(19) United States
(12) Patent Application Publication
(10) Pub. No.: US 2007/0231727 A1
(43) Pub. Date: Oct. 4, 2007

(54) Toner formulations containing extra particulate additive

(76) Inventors: Brian William Baird, Louisville, CO (US); John Joseph Earley, Boulder, CO (US); Yueping Fu, Longmont, CO (US); Rick Owen Jones, Berthoud, CO (US); Lale Gokbudak Lovell, Longmont, CO (US); George Pharris Marshall, Boulder, CO (US); John Melvin Olson, Boulder, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/395,692

(22) Filed: Mar. 31, 2006

(51) Int. Cl. G03G 9/08

(52) U.S. Cl. 430/108.4; 430/108.1; 430/110.1; 430/108.6; 430/108.7

(57) ABSTRACT

The present invention relates to the use of extra particulate additives in selected chemically processed toner compositions for use in an image forming apparatus. The extra particulate additive may have a controlled aspect ratio and be combined with the chemically processed toner. The chemically processed toner may provide toner particles having controlled diameters and rheological properties that may be combined with a release agent. The release agent may also be selected with respect to, e.g., concentration and/or mean domain size within the toner particles including considerations of coating chemistry and/or DSC melting behavior.

### FIELD OF INVENTION

The present invention relates to the use of extra particulate additive (EPA) in toner compositions for an image forming apparatus. The EPA may have a designated aspect ratio and be specifically employed in a chemically processed toner along with controlled levels of a release agent. The chemically processed toner may be sourced from chemical methods such as an emulsion aggregation process.

### BACKGROUND

Toner particles may be formed by the process of compounding a polymeric resin, with colorants and optionally other additives. These ingredients may be blended through, for example, melt mixing. The resultant materials may then be ground and classified by size to form a powder. Toner particulate compositions may also be formed by chemical methods in which the toner particles are prepared by chemical processes such as suspension polymerization or emulsion aggregation rather than being abraded from larger sized materials by physical processes. Toner compositions so formed may be used in electrophotographic printers and copiers, such as laser printers wherein an image may be formed via use of a latent electrostatic image which is then developed to form a visible image on a drum which may then be transferred onto a suitable substrate.

### SUMMARY

One exemplary aspect of the present invention relates to an image forming composition comprising extra particulate additive in combination with a chemically processed toner. The chemically processed toner may include toner particles having a particle diameter in the range of about 1-25 microns. A release agent may be included at a concentration of greater than 3.0% (wt). The extra particulate additive may include acicular particles such as an inorganic oxide having a diameter of about 0.01 to 10 microns and a length between about 1-100 microns.

Another exemplary aspect of the present invention relates to a method of improving the flow of chemically processed toner particles in an image forming apparatus. The method may include supplying chemically processed toner particles, wherein the particles have a particle diameter in the range of about 1 microns to about 25 microns and a release agent at a concentration of greater than about 3.0% (wt). A mixture may then be formed of the toner particles with an acicular extra particulate additive. The extra particulate additive may again include an inorganic oxide having a diameter of about 0.01 to 10 microns and a length between about 1-100 microns. The mixture may be supplied to an image forming apparatus wherein the extra particulate additive may be removed from the toner particles as the toner is physically conveyed within the image forming apparatus. Such removal may assist in maintaining an adequate flow of toner from a toner hopper towards a desired location within the image forming apparatus.

### BRIEF DESCRIPTION OF THE DRAWINGS

The detailed description below may be better understood with reference to the accompanying figures which are provided for illustrative purposes and are not to be considered as limiting any aspect of the invention.

FIG. 1 is a plot of a DSC performed on a representative toner of the present invention containing black pigment, illustrating the onset and peak melting temperatures of the release agent.

FIG. 2 is a plot of a DSC performed on a representative toner of the present invention containing cyan pigment, illustrating the onset and peak melting temperatures of the release agent.

FIG. 3 is a plot of a DSC performed on a representative toner of the present invention containing magenta pigment, illustrating the onset and peak melting temperatures of the release agent.

FIG. 4 is a plot of a DSC performed on a representative toner of the present invention containing yellow pigment, illustrating the onset and peak melting temperatures of the release agent.

FIG. 5 is a comparative plot of the DSC results of FIGS. 1-4.

### DETAILED DESCRIPTION

The present invention relates to a formulation of toner particles for use in an image forming device. The toner particles may be modified with extra particulate additives such as an inorganic oxide which may be surface treated with other chemical reagents which may regulate hydrophobic and/or hydrophilic properties. Such modified toner particles may prevent starvation or bridging of the toner which may cause print defects. The image forming devices may include printers, electrophotographic printers, copiers, fax machines, all-in-one devices, multi-functional devices, etc.

The toner particles may be advantageously prepared by chemical methods, and in particular an emulsion aggregation procedure, which generally provide resin, colorant and other additives. More specifically, the toner particles may be prepared via the steps of initially preparing a polymer latex from ethylene type monomers, in the presence of an ionic type surfactant, such as an anionic surfactant having terminal carboxylate (—COO⁻) functionality. The polymer latex so formed may be prepared at a desired molecular weight distribution and may, e.g., contain both relatively low and relatively high molecular weight fractions to thereby provide a relatively bimodal molecular weight distribution. Pigments may then be milled in water along with a surfactant that has the same ionic charge as that employed for the polymer latex. Release agent (e.g. a wax or mixture of waxes) may also be prepared in the presence of a surfactant that assumes the same ionic charge as the surfactant employed in the polymer latex. Optionally, one may include a charge control agent. The polymer latex, pigment latex and wax latex may then be mixed and the pH adjusted to cause flocculation. For example, in the case of anionic surfactants, acid may be added to adjust pH to neutrality. Flocculation therefore may result in the formation of a gel where an aggregated mixture may be formed with particles of about 1-2 μm in size. Such mixture may then be heated to cause a drop in viscosity and the gel may collapse and relative loose (larger) aggregates, from about 1-25 μm may be formed, including all values and ranges therein. For example, the aggregates may have a particle size between 3 μm to about 15 μm, or between about 5 μm to about 10 μm. In addition, the process may be configured such that at least about 80-99% of the particles fall within such size ranges, including all values and increments therein. Base may then be added to increase the pH and reionize the surfactant or one may add additional anionic surfactants. The temperature may then be raised to bring about coalescence of the particles, which then may be washed and dried. Coalescence is reference to fusion of all components.

The above procedure therefore offers flexibility in the selection of resin components and pigments (colorants) and it may be appreciated that a wide variety of surfactants (either anionic or cationic) may be employed. As noted, the process may rely upon pH to alter the charge on a surfactant to stabilize disperse particles, which may amount to deprotonating a cationic or protonation of an anion.

As alluded to above, the resins contemplated herein may therefore include resins sourced from monomers having ethylene unsaturated bonds that may be subject to free radical polymerization. The resins may therefore include styrenes, acrylates, maleates methacrylates, butadiene, isoprene, acrylic acid, methacrylic acid, acrylonitrile, vinyls, etc. Other resins may also be contemplated such as condensation polymers, including polyamide and/or polyester resins, of a linear, branched or even crosslinked configuration. The resins may also be modified such that they contain functional groups (e.g. an ionic group) which may allow the resin to more directly disperse in an aqueous medium without the need for surfactants.

Where the polymeric resins are prepared via emulsion or suspension polymerization, initiators may include, for example, peroxides or persulfates. Water soluble initiators may be employed in the case of an emulsion polymerization and water insoluble initiators may be employed in the case of suspension polymerization.

The various pigments which may be included include pigments for producing cyan, black, yellow or magenta toner particle colors. The pigments themselves may range in particle size between 10 nm and 2 μm, including all values and increments therebetween. The pigments may be included within a range of about 2 to 12% by weight. Additional additives may also be incorporated into the toner particles such as charge control agents and release agents. Such additives may be incorporated into the pigment latex or may be incorporated in the polymer latex or may be incorporated as an individual dispersion.

The release agent may be included in the final toner composition within a range of greater than about 3.0% by weight, including all increments and ranges therein, such as between about 4% to 15.0% by weight, or at a more specific level of, e.g. about 10%. The release agent may also have a number average molecular weight (Mn) of greater than about 500. Moreover, the release agent may have a Mn of between about 501-20,000, including all values and increments therein. Exemplary release agents may include one or more vegetable waxes, mineral waxes, petroleum waxes or synthetic waxes, such as hydrocarbon wax, paraffin wax, carnauba wax, chemically modified waxes, etc. For example, for a given weight percent of release agent, the release agent may comprise a mixture of waxes. That is, the hydrocarbon wax may account for 20-99% of the mixture and a carnauba wax may be present that accounts for 1-80% of the mixture, including all values and increments therein. The hydrocarbon wax may specifically be sourced as a “Fischer-Tropasch” wax. Accordingly, in an exemplary embodiment, the release agent may include a formulation that contains greater than 50% Fisher Tropasch wax relative to the presence of the carnauba wax. For example, a release agent formulation that contains about 80% Fisher Tropasch wax and about 20% carnauba wax. In that sense the invention herein contemplates a mixture of a hydrocarbon (or relatively non-polar) wax in combination with wax substances that are relatively more polar, and are based upon esters of fatty acids, fatty alcohols, esterified fatty diols, hydroxlated fatty acids and/or ethoxylated fatty alcohols.

The release agent, in the form of a wax, may also have a specific wax domain size in the toner particles which may be monitored and controlled in the following manner. The toner particles may be embedded in a cured polymeric type resin and sections of about 25-300 nm may be cut using a diamond knife. Transmission electron microscopy (TEM) images may then be employed at about 17,000 magnification. The size of about 100 wax domains may then be measured using image analysis software (e.g., Zeiss KS300). Pursuant to this methodology, the wax domain size may be controlled to have a mean wax domain size of between about 0.10-1.20 μm, including all values and increments therein. For example, the wax domain size may have a value of about 0.40-1.00 μm, or 0.50-0.90 μm, or the individual values of about 0.50 μm, 0.60 μm, 0.70 μm, etc. Furthermore, the wax may have a minimum wax domain size of 0.01 microns and a maximum wax domain size of about 4.0 microns. Such wax domain size may effect and advantageously define or influence the compatibility of the wax within a given continuous phase of resin polymer.

The release agent (wax) may also have a crystalline phase as defined by a differential scanning calorimetry (DSC) peak melting point temperature of between about 75° C. to about 105° C. This may be understood at the peak in the melting endotherm of the wax within a toner composition (e.g. black, cyan, magenta or yellow) by a given DSC heating scan. Furthermore, the wax herein may have more than one crystalline form or size as defined by multiple peak melting points (i.e. a plurality of peaks) within the range of 75-105° C. In addition, the release agent (wax) may be characterized herein by a DSC onset melting temperature. This may correspond to the temperature at which a first endothermic melting event may begin (i.e. shift from a baseline) on a given DSC trace. Such DSC onset melting temperature of the release agent (wax) herein, suitable to optimize release performance in a given electrophotographic printer, may be equal to or greater than about 40° C. It may also be equal to or greater than about 50° C., 60° C., 70° C., including any temperature up to about 100° C.

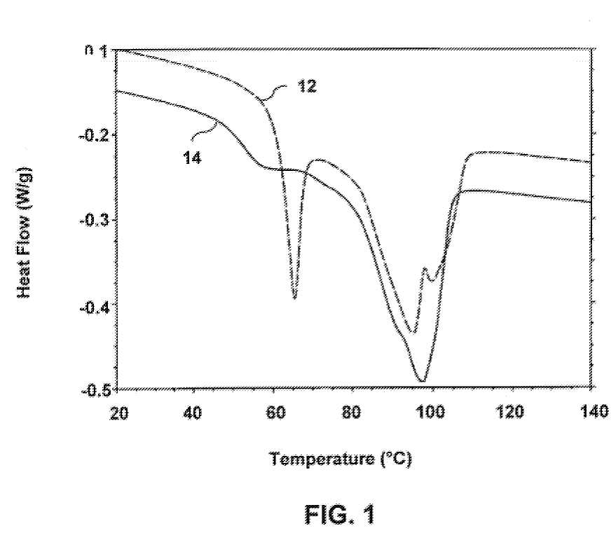

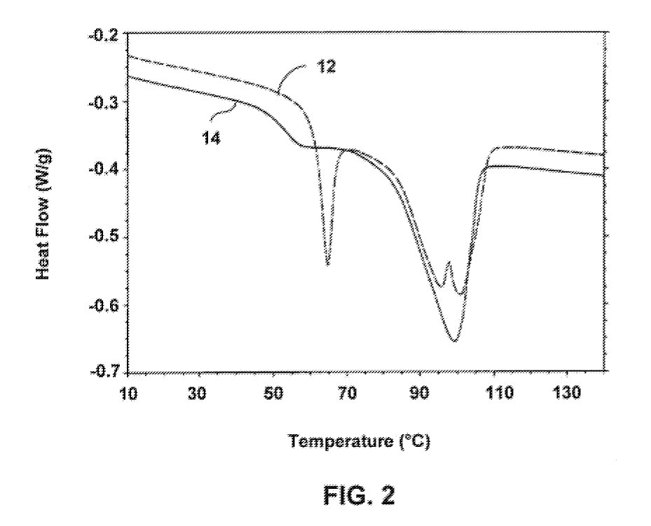

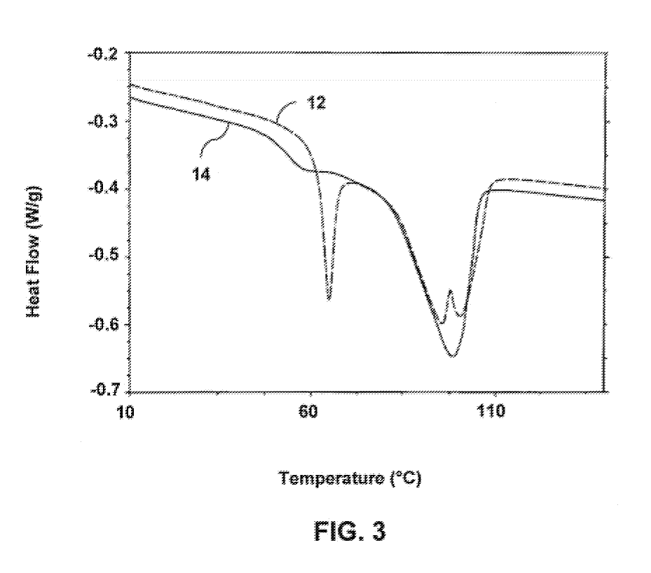

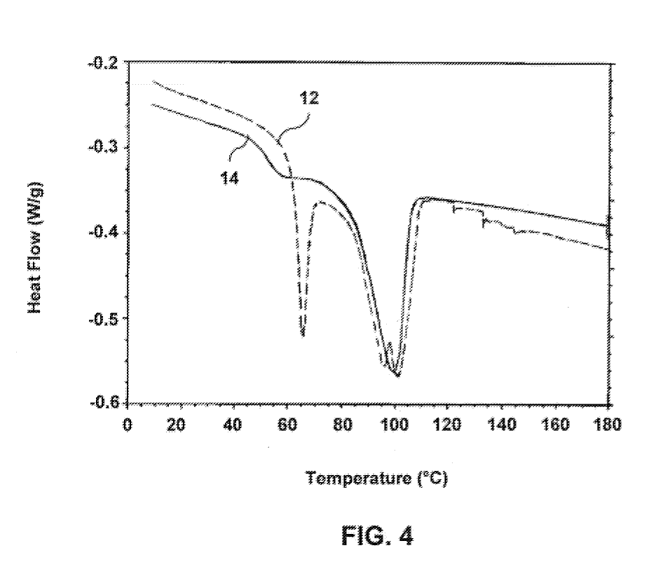

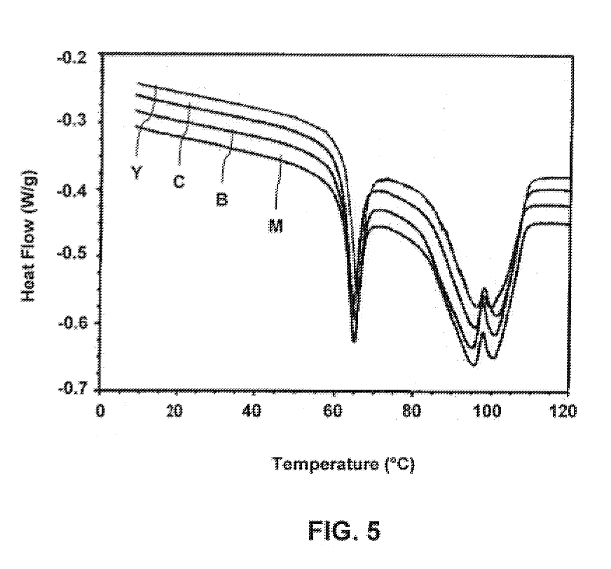

FIGS. 1-5 illustrate exemplary DSC plots 10 for black, cyan, magenta and yellow pigmented toner. As can be seen from FIGS. 1-4, a first scan 12 and second scan 14 were performed on each sample of toner containing release agent (wax). FIG. 5 provides a comparative plot of the results for the various pigmented toners (Y=Yellow; C=Cyan; B=Black and M=Magenta). The results of the DSC scans may also be tabulated and are provided in Table 1.

TABLE 1
DSC Results

| | 1^{st} Scan | 1^{st} Scan | 1^{st} Scan | 2^{nd} Scan | 2^{nd} Scan | 2^{nd} Scan | |
|---|---|---|---|---|---|---|---|
| | Onset Tg | Peak Melt | Wax ΔH_{f} | Onset Tg | Peak Melt | Wax ΔH_{f} | DSC |
| Sample | (° C.) | Tg (° C.) | J/gm | (° C.) | Tg (° C.) | J/gm | Trace |
| Black | 60 | 95 | 20.4 | 47 | 97 | 21.9 | |
| Cyan | 61 | 96 | 22.4 | 47 | 99 | 23.5 | |
| Magenta | 61 | 95 | 22.1 | 47 | 98 | 23.5 | |
| Yellow | 61 | 96 | 20.9 | 47 | 99 | 23.3 | |

The resulting toner particles may also be optimized for performance and characterized by rheological considerations, such as a complex viscosity (\acute{η}) between about 500 to 1500 Pa·s at 160° C. and a tan delta value of between about 0.4 to 2.5. Table 2 illustrates exemplary toner particle complex viscosity and tan delta measurements. The measurements were performed at a sinusoidal oscillation frequency of 6.28 rad/s, using a 25 mm sample.

TABLE 2
Viscosity Measurements

| | Complex Viscosity @ | |
|---|---|---|
| Toner | 160° C. [Pa · s] | Tan Delta |
| Cyan | 731.8 | 0.736-2.165 |
| Black | 1204.9 | 0.813-2.405 |
| Yellow | 998.8 | 0.824-2.125 |
| Magenta | 1096.3 | 0.455-1.672 |

As noted, additives may then be incorporated onto the toner particles such as extra particulate additives on the surface of a toner particle. As alluded to above, such additives may serve to improve the flow or physical conveyance of the above-referenced chemically produced toner particles within an image forming apparatus. In particular, flow/conveyance has been specifically improved in those chemically produced toner compositions described herein containing the indicated release agent (wax) at the specified concentration of greater than about 3.0% (wt.).

More specifically, the additives may be acicular in structure having a length of between about 1 to 10 microns and any increment or value therein and a diameter of between about 0.01 to 100 microns and any increment or value therein. Acicular may be understood as a general reference to a shape wherein one dimension (e.g. length) exceeds another dimension (e.g., width). The particles may be metal particles or metal oxide particles, such as titanium dioxide. The particles may also be surface treated. For example, the acicular particles may be treated with silicon oxide and/or one or more metal oxides, including for example aluminum oxide, cerium oxide, iron oxide, zirconium oxide, lanthanum oxide, tin oxide, antimony oxide, indium oxide, etc. One particular exemplary particle includes acicular titanium dioxide particles surface treated with aluminum oxide, which may be obtained from Ishihara Corporation, USA. The acicular particles may also be treated with one or more organic reagents, such as a functional organic reagent.

Accordingly, the organic reagents for surface treatment may include hydrophobic or hydrophilic polymers or even fatty acid type reagents or reactive silanes such as dichloro-dimethyl silane, hexamethyl disilazane or alkoxy silanes. Exemplary hydrophobic polymers may include organosilicon compounds including polydimethylsiloxane (PDMS). Exemplary fatty acid reagents may include fatty acids characterized by the formula CH₃(CH₂)ₙCOOH, wherein n is in the range of at least about 10, and includes values of up to about 50.

The acicular particles may have a specific gravity of between 3.0 to 6.0 including all increments or values therebetween, such as between 4.0 and 5.0. Furthermore, as measured by the BET method, the particles may have a specific surface area of between 1-100 m²/g and any value or increment therebetween. The pH of the acicular particles may be between 5-9 and any increment or value therebetween. The particles may also have an electrical resistivity of between approximately 0.1 ohm-cm to 1×10¹² ohm-cm, including all incremental values and ranges therebetween such as 1×10⁸ ohm-cm. The particles may be present in the range of 0.5-5.0% (wt) in the toner including all values and increments therein.

In addition, the acicular particles may involve a mixture. For example, the particles may contain more than one type of inorganic oxide particle and may therefore amount to a mixture of inorganic oxides, where a portion of the inorganic oxides may be surface treated and where a portion of the particles may not contain surface treatment. Therefore, the inorganic surface treated particles may be present between 1-99% and the untreated particles may be present between 1-99%.

It has also been observed herein that with respect to the various formulations herein, a portion of the extra particulate additives may be observed to physically dissociate from the toner particles during the printing process, such as when the toner particles are physically transferred through a toner cartridge in an image forming apparatus. Approximately between about 0.5 to 10% (wt.) of the total amount of extra particulate additive present in the toner may therefore dissociate from the toner particles during transfer, including all increments and any individual value therein. The extra particulate additives may therefore remain within a given image forming apparatus or toner cartridge after a printing operation, and locate on doctor blades or within the foam pores of a toner adder roller or on the surface of an elastomeric developer roller or charge roller.

Accordingly it may be appreciated that the present invention provides the opportunity to optimize the underlying toner composition with respect to one, several or all of the aforementioned variables (e.g., release agent concentration, release agent domain size, toner rheology, etc.) which may be chosen herein to provide improved performance in a given electrophotographic printer (e.g., fusing at desirable temperatures and at desired rates or within a desired temperature range, control of filming and hot offset, and relatively more stable ship-store characteristics). In addition, with respect to such ability to optimize and regulate toner performance, such optimized toner formulations may now be combined with extra particulate additive to influence physical flow in a given environment, such as the flow of toner from a given toner hopper onto a developer roller proceeding to and through a region of relatively high pressure such as the nip located within the photoconductor drum assembly or fuser assembly.

The foregoing description is provided to illustrate and explain the present invention. However, the description hereinabove should not be considered to limit the scope of the invention set forth in the claims appended here to.

What is claimed is:

1. An image forming composition comprising:
chemically processed toner including toner particles having a particle diameter in the range of about 1-25 microns;
a release agent at a concentration of greater than 3.0% (wt); and
an acicular extra particulate additive comprising an inorganic oxide having a diameter of about 0.01 to 10 microns and a length between about 1-100 microns.

2. The image forming composition of claim 1 wherein said acicular extra particulate additive is present at a concentration of greater than 0.10% (wt).

3. The image forming composition of claim 1 wherein said release agent has a mean wax domain size of between about 0.10-1.20 microns.

4. The image forming composition of claim 3 wherein said release agent has a minimum wax domain size of about 0.01 microns and a maximum wax domain size of about 4.00 microns.

5. The image forming composition of claim 1 wherein said release agent has a DSC peak melting point temperature of between about 75-105° C.

6. The image forming composition of claim 5 wherein said release agent has a DSC onset melting temperature of greater than about 40° C.

7. The image forming composition of claim 1 wherein said image forming composition includes said release agent at a concentration of between about 4-15% (wt).

8. The image forming composition of claim 1 wherein said release agent comprises a mixture of hydrocarbon wax and carnauba wax.

9. The image forming composition of claim 1 wherein said toner particles have a complex viscosity of between about 500 to 1500 Pa·s at 160° C.

10. The image forming composition of claim 1 wherein said toner particles have a tan delta value of between about 0.4-2.5.

11. The image forming composition of claim 1 wherein said additive has an electrical resistivity of between approximately 0.1 ohm-cm to 1×10¹² ohm-cm.

12. The image forming composition of claim 1 wherein said acicular extra particulate additive comprises an inorganic oxide surface treated with a metal oxide.

13. The image forming composition of claim 12 wherein said metal oxide is selected from the group consisting of aluminum, cerium, iron, zirconium, lanthanum and mixtures thereof.

14. The image forming composition of claim 1 wherein said acicular extra particulate additive comprises an inorganic oxide surface treated with silicon oxide.

15. The image forming composition of claim 1 wherein said acicular extra particulate additive comprises an inorganic oxide surface treated with organic reagent.

16. The image forming composition of claim 15 wherein said organic reagent is selected from the group of hydrophilic polymers, hydrophobic polymers, fatty acids, reactive silane, and mixtures thereof.

17. The image forming composition of claim 1 wherein said acicular extra particulate additive metal oxide comprises a mixture of an inorganic oxide surface treated with a metal oxide and an inorganic oxide that does not contain surface treatment.

18. The image forming composition of claim 1 wherein said extra particulate additive has a specific gravity of between about 3.0 to 6.0.

19. The image forming composition of claim 1 wherein said chemically processed toner includes pigment at a level of about 2-12% (wt).

20. The image forming composition of claim 1 wherein said release agent has a Mn of greater than 500.

21. The image forming composition of claim 1 wherein said extra particulate additive is capable of dislodging from said toner particles when said toner is physically conveyed within an image forming apparatus.

22. A method of improving the flow of chemically processed toner particles in an image forming apparatus comprising:
supplying chemically processed toner particles, wherein said particles have a particle diameter in the range of about 1 microns to about 25 microns and a release agent at a concentration of greater than about 3.0% (wt);
forming a mixture of toner particles and an acicular extra particulate additive comprising an inorganic oxide having a diameter of about 0.01 to 10 microns and a length between about 1-100 microns; and
supplying said mixture to an image forming apparatus wherein said extra particulate additive is removed from said toner as said toner is physically conveyed within said image forming apparatus.
